(19) United States
(12) Patent Application Publication
(10) Pub. No.: US 2020/0061672 A1
(43) Pub. Date: Feb. 27, 2020

(54) Device and Method for Mineral Classifying

(71) Applicant: John Mathew Vella, Stamford, CT (US)

(72) Inventor: John Mathew Vella, Stamford, CT (US)

(21) Appl. No.: 16/276,868

(22) Filed: Feb. 15, 2019

Related U.S. Application Data
(60) Provisional application No. 62/720,739, filed on Aug. 21, 2018.

(51) Int. Cl. B07B 1/02

(52) U.S. Cl. CPC B07B 1/02; B07B 2201/02; B07B 2230/01

(57) ABSTRACT

A classifying device comprising: a bin having an open top face; a flat screen extending along a plane and configured for extending over and fully covering the open top face of the bin, the screen having a netting configured to enable passage of material smaller than a desired size therethrough into the bin; and two flanges disposed at two respective opposite sides of a perimeter of the screen. The device is configured for being placed in a water stream with a water level just above the screen and the flanges disposed substantially along a direction of a water flow of the stream, such that the flanges decrease escape of the water through the sides at which the flanges are disposed, thereby increasing a speed of the water flow over the screen in the direction of the water flow of the stream.

### TECHNICAL FIELD

The present invention relates to mineral classifying.

### BACKGROUND OF THE INVENTION

Classification is the most important part of mining/prospecting for gold or any valuable minerals.

In classifying, alluvial deposit is scooped onto a classifier which is placed over a bin or bucket filled with water. The deposit is then gently agitated while rinsing with water with a separate bucket to rinse the heavy smaller rocks, dirt, & gold to fall into the bin or bucket below the classifier. The material left in the classifier is then looked over for valuable minerals like gold nuggets before discarding. The material that falls into the bin or bucket is the material that needs to be processed further by binning or sluicing.

### BRIEF SUMMARY OF EMBODIMENTS OF THE INVENTION

The present invention is aimed at a classifying device and method that facilitates the process of classifying for gold (or any other desired precious metal), because it alleviates the washing process and allows the prospector to move more material much quicker and with less efforts, save his energy for digging.

An aspect of some embodiments of the present invention relates to a classifying device comprising a bin, a flat screen, and two flanges. The bin has an open top face. The flat screen extends along a plane and is configured for extending over and fully covering the open top face of the bin, the screen having a netting configured to enable passage of material smaller than a desired size therethrough into the bin. The two flanges are disposed at two respective opposite sides of a perimeter of the screen and extend away from the plane of the screen and away from the bin. The device is configured for being placed in a water stream with a water level just above the screen and the flanges disposed substantially along a direction of a water flow of the stream, to allow unimpeded water flow over the screen between the two flanges, such that the flanges decrease escape of the water through the sides at which the flanges are disposed, thereby increasing a speed of the water flow over the screen in the direction of the water flow of the stream.

In a variant, the flanges are perpendicular to the plane of the screen.

In another variant, the flanges are parallel to each other.

In a further variant, the flat screen is removably joined to the bin.

In yet a further variant, the flanges are attached to the bin.

In a variant, the flanges are joined to the screen.

In another variant, the screen comprises a frame and a mesh. The frame describes a perimeter of a planar polygonal shape having the two sides opposite to each other which do not touch each other, the flanges extending from the two sides. The mesh is held by the frame and stretches along the plane of the polygonal shape, the mesh having a netting configured to enabling passage of the material smaller than the desired size therethrough.

The screen may include a stabilizing shaft joined to two non-touching sides of the frame to increase a rigidity of the frame.

Optionally, each of the two sides of the polygonal shape comprises an elongated bar of the frame and a flanged runner. Each of the flanged runners comprises an elongated planar board and a wall having an edge common with the elongated planar board and extending at an angle from the board. Each of the flanged runners is joined to a respective one of the elongated bars, sandwiching a respective portion of the mesh between the bar and the board of the runner. Each of the walls forms the respective flange.

In a further variant, the classifying device further comprises a flared add-on removably joined to the screen, the flared add-on comprising a flat surface and two side walls. The flat surface has a distal end longer than a proximal end thereof, the flat surface having two lateral sides tapering from the distal end to the proximal end, the proximal end of the flat surface having a length which is about equal to a length of the screen, the proximal end forming a neck in which the lateral sides are parallel to each other. Each side wall comprises a respective distal portion and a respective proximal portion, the proximal portions being parallel to each other. Each proximal portion being configured for being joined to a respective one of the flanges, so that the flat surface extends distally from screen.

Optionally, the classifying device further comprises two wall extensions, wherein each wall extension is removably attachable to the respective proximal portion.

In some embodiments of the present invention, the flat surface includes a non-tapering neck extending proximally at the proximal end of the flat surface, the non-tapering neck being configured for covering part of the screen when the add-on is joined to the screen.

In a variant, the classifying device further comprises a flat panel configured for being placed on the screen and a mat having a gold-trapping surface, the mat being configured to be placed on the flat panel to enable the classifying device to be used for gold sluicing, such that a section of the mat is sandwiched between the flat panel and the non-tapering neck.

In another variant, the classifying device further comprises a mat having a gold-trapping surface configured to be placed on the screen to enable sluicing the classifying device to be used for gold sluicing.

In a further variant, the classifying device further comprises two shoulder straps joined to the bin, such that the bottom of the bin faces a user then the user wears the shoulder straps.

Another aspect of some embodiments of the present invention relate to a screen for use in conjunction with a bin for classifying for material in a stream. The screen includes a flat netting and two flanges. The flat netting extends along a plane and is configured for extending over and fully covering an open top face of the bin, the netting being configured to enable passage of material smaller than a desired size therethrough into the bin. The two flanges are disposed at two respective opposite sides of a perimeter of the netting and extend away from the plane of the netting and away from a bottom of the bin.

In a variant, the flanges are perpendicular to the plane of the screen.

In another variant, the flanges are parallel to each other.

In yet another variant, the screen includes a frame and a mesh. The frame describes a perimeter of planar polygonal shape having the two sides opposite to each other which do not touch each other, the flanges extending from the two sides. The mesh is held by the frame and stretches along the plane of the polygonal shape, the mesh having a netting configured to enabling passage of the material smaller than the desired size therethrough.

In a further variant, each of the two sides comprises an elongated bar of the frame and a flanged runner. Each of the flanged runners comprises an elongated planar board and a wall having an edge common with the elongated planar board and extending at an angle from the board. Each of the flanged runners is joined to a respective one of the elongated bars, sandwiching a respective portion of the mesh between the bar and the board of the runner. Each of the walls forms the respective flanged.

### BRIEF DESCRIPTION OF DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a perspective view of a device for classifying minerals having two flanges, according to some embodiments of the present invention;

FIGS. 2 and 3 are perspective views of a device for classifying, in which the flanges are attached to the bin, according to some embodiments of the present invention;

FIGS. 4a and 4b are perspective views of a device for classifying, in which the flanges are joined to the screen, according to some embodiments of the present invention;

FIGS. 5 and 6 illustrate a non-limiting example of in which the screen includes a mesh sandwiched between a frame and flanged runners, according to some embodiments of the present invention;

FIG. 7 illustrate a non-limiting example in which the flanged runners are joined to the mesh and the frame, according to some embodiments of the present invention;

FIGS. 8-13 illustrate different stages in the use of the classifying device, according to some embodiments of the present invention;

FIG. 14 is a flowchart illustrating a method for classifying in a stream, according to some embodiments of the present invention;

FIGS. 15a and 15b illustrate a flare add-on configured to be joined to the screen, according to some embodiments of the present invention; and

FIG. 16 illustrates a classification kit configured to be carried and dragged by a user, according to some embodiments of the present invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

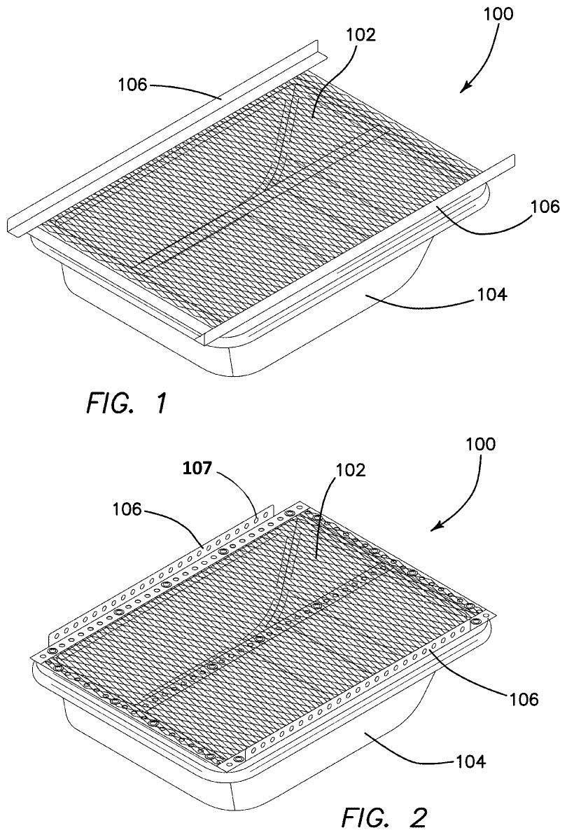

FIG. 1 is a perspective view of a device 100 for classifying having two flanges, according to some embodiments of the present invention.

The device 100 includes a screen 102, a bin 104, and two flanges 106.

The bin 104 has an open top face and the screen 102 extends over the open face of the bin 104 to fully cover the open face and optionally the rim of the bin 104. The screen has a netting configured for enabling material smaller than a desired size to pass therethrough into the bin, while retaining particles larger than the desired size. The flanges 106 are disposed at two respective opposite sides (edges) of the screen 102. The flanges extend away at an angle from the screen and away from the bin. The sides of the bin and screen may be straight or curved. The shape of the flanges matches the shape of the sides of the bin and the screen, and may therefore be straight or curved as well.

The classifying device 100 is configured for being placed in a water stream, with the water level just above the screen 102, while the flanges 106 extend above the water level and are disposed substantially along a direction of the flow of the stream. The unflanged sides of the device provide openings for water to enter the space between the flanges, flow above the screen, and then leave the space between the flanges without blocking the flow of water. The water flow over the screen 102 is substantially unimpeded along the direction of the water flow, while the flanges 106 create a channel to decrease the escape of the water through the sides of the classifying device. In this manner the speed of the water flow over the stream is increased in the direction of the water flow. In this manner, undesirable material from the deposit is more quickly carried away by the water's flow.

In some embodiments of the present invention, the netting of the screen is made of steel stucco netting. Other materials may be used and are within the scope of the present invention.

According to some embodiments of the present invention, the flanges 106 are substantially perpendicular to the plane of the screen 102. Optionally, the flanges 106 are substantially parallel to each other.

In a variant, the screen 102 is removably joined to the bin 104. In this manner, screen can be removed after the classifying process, and the user can easily remove the collected material from the bin.

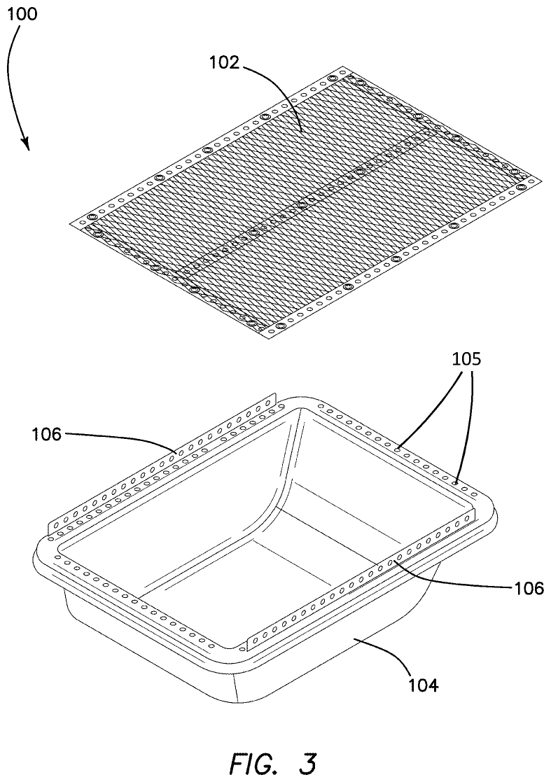

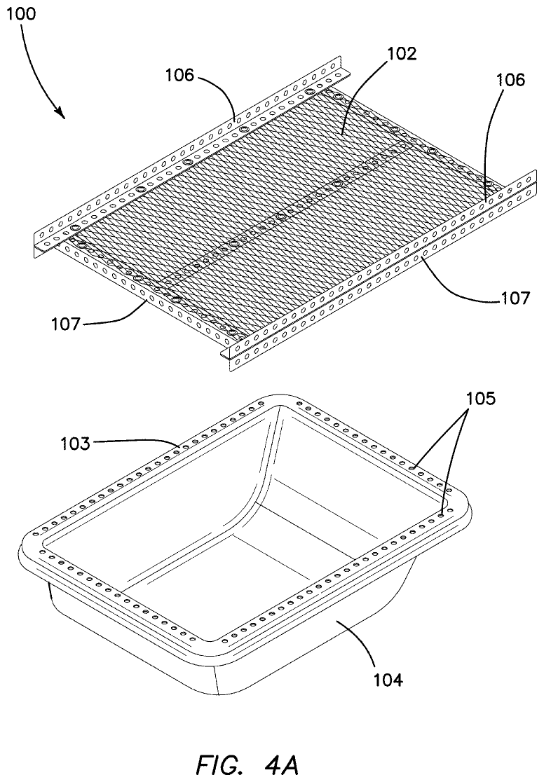

FIGS. 2 and 3 are perspective views of a classifying device, in which the flanges 106 are attached to the bin 104 and the screen 102 is removable from the bin 104, according to some embodiments of the present invention. FIG. 2 shows the screen 102 joined to the bin 104. FIG. 3 shows an exploded view of the classifying device 100, in which it is clear that the flanges 106 are attached to the bin 104 and not removable from the bin.

In some embodiments of the present invention, the flanges 106 are attached to the bin 104. In these embodiments, two opposite sides of the bin extend above the other sides of the bin.

In some embodiments of the present invention, the bin 104 includes a rim 103 extending outwards. Optionally, holes 105 (e.g., holes with a diameter of 5/16 inches) are drilled on one or more portions of the rim 103 of the bin 104 in order to be able to fasten the bin to equipment for dragging or floating the classifying device 100 to a work site or processing site. In some embodiments of the present invention, only eight holes are present, two holes for each corner of the rim 103. In some embodiments of the present invention the flanges 106 include one or more second holes 107 disposed along a length of each flange. As will be seen below, these holes may be used for joining add-ons to the flanges.

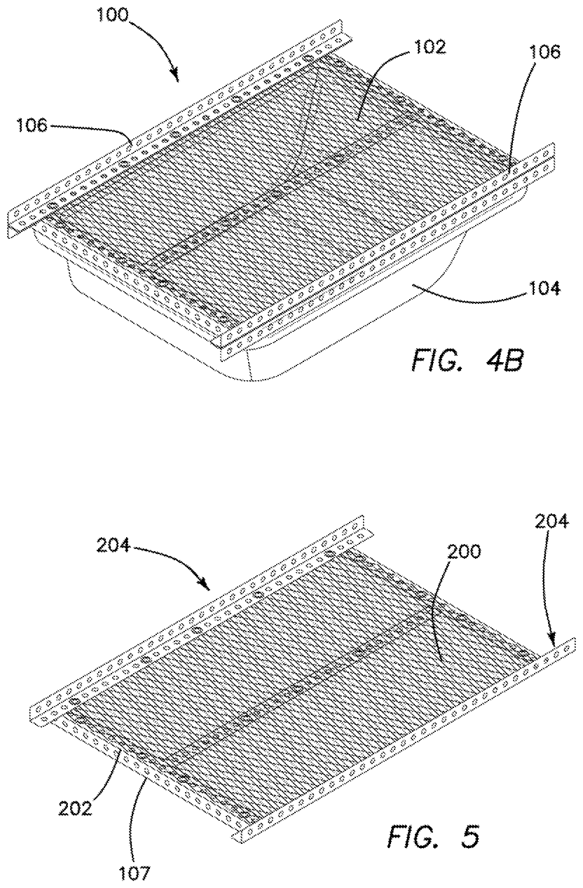

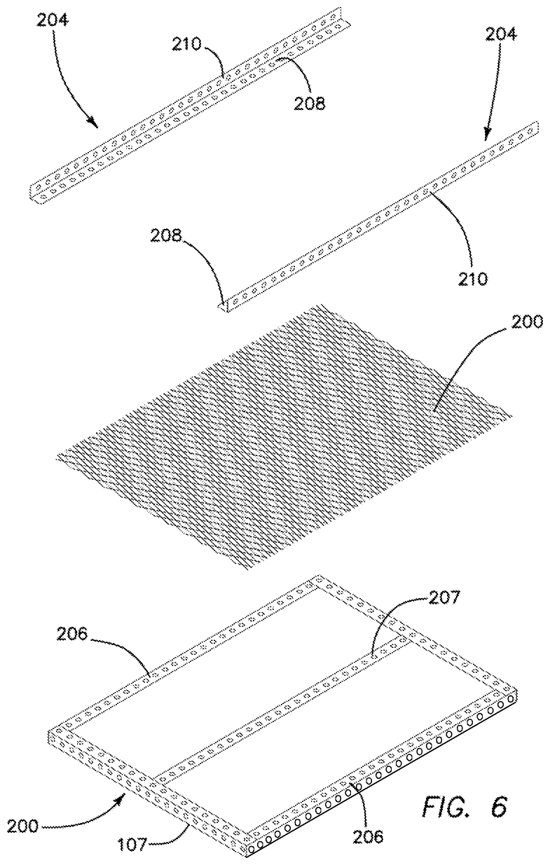

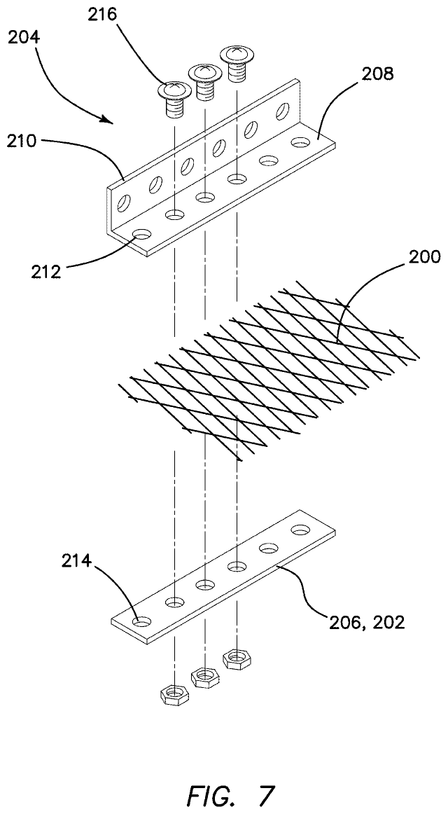

FIGS. 4a and 4b are perspective views illustrating a classifying device 100, in which the flanges 106 are joined to the screen 102 (which includes an angle frame as will be described in FIGS. 5 and 6), according to some embodiments of the present invention. In FIG. 4a, the screen 102 is separated from the bin 104. In FIG. 4b, the screen 102 is joined to the bin 104, by being snapped onto the bin.

In the embodiment of FIGS. 4a and 4b, the flanges 106 are joined to sides of the screen 102. If the screen 102 is removably joined to the bin 104, when the screen 102 is removed from the bin 104, the flanges 106 are removed as well.

In some embodiments of the present invention, the bin 104 includes a rim 103 extending outwards. Optionally, holes 105 (e.g., holes with a diameter of 5/16 inches) are drilled on one or more portions of the rim 103 of the bin 104 in order to be able to fasten the bin to equipment for dragging or floating the classifying device 100 to a work site or processing site. In some embodiments of the present invention, only eight holes are present, two holes for each corner of the rim 103.

According to some embodiments of the present invention, the screen includes a frame having a protrusion 107 extending downwards perpendicularly to the screen from at least a part of the perimeter of the frame. When the screen 102 closes the bin 104, the protrusion 107 surrounds the rim 103 and snaps to the rim, securing the screen to the bin, and ensuring that the screen does not detach itself from the bin during use.

FIGS. 5 and 6 illustrate a non-limiting example of in which the screen 102 includes a mesh 200 sandwiched between a frame 202 and flanged runners 204, according to some embodiments of the present invention. In FIG. 5, the mesh, frame, and runners are joined to each other. In FIG. 6, an exploded view of the mesh, frame, and runners is shown.

In some embodiments of the present invention, the screen includes a mesh 200 and a frame 202. The frame 202 describes the perimeter of a planar polygonal shape having two sides opposite to each other that to do touch each other. The flanges extend from the two sides. The mesh 200 is held by the frame and stretches along the plane of the polygonal shape. The mesh 200 has a netting configured for allowing passage of material smaller than a certain size therethrough. The polygonal shape described by the frame 202 may be rectangular.

Optionally, the sides of the frame are made of pig iron and are welded together. Any other material can be used and is within the scope of the present invention.

Optionally, the flanges are not integral with the frame 202. The frame includes elongated bars 206 which define the sides of the polygonal shape. The mesh 200 extends over the elongated bars 206. Two flanged runners 204 are joined to two opposite sides of the frame. Each flanged runner 204 includes an elongated planar board 208 and a wall 210 extending at an angle from the board. The angle may be, for example, 90 degrees or any other angle between (but not including) 0 and 180. The walls 210 of the flanged runners 204 form the flanges of the classifying device.

In some embodiments of the present invention, the frame 202 includes a stabilizing shaft 207 having ends joined to two non-touching sides of the frame in order to increase the rigidity of the frame. The stabilizing shaft 207 may also provide support the mesh 200 to maintain the planar shape of the mesh 200.

Optionally, the sides of the frame are made of pig iron and are welded together. Any other material can be used and is within the scope of the present invention. The sides of the frame may be joined together in any other known manner, for example, via screws, bolts, etc.).

Each flanged runner 204 is joined to a respective elongated bar 206 of the frame 202. In some embodiments of the present invention, the board 208 of a respective runner 210 is joined to a respective elongated bar 206 of the frame 202, such that a portion of the mesh 200 is sandwiched between the board 208 and the elongated bar 206.

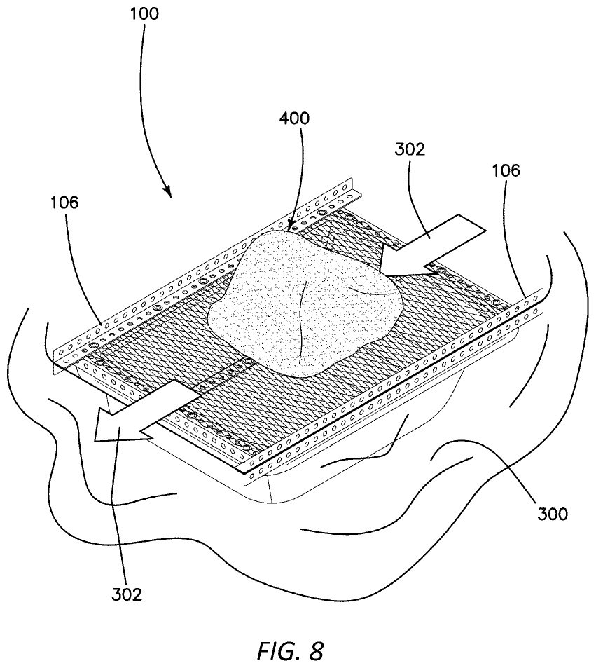

FIG. 7 illustrate a non-limiting example in which the flanged runners 204 are joined to the mesh 200 and the frame 202, according to some embodiments of the present invention.

In some embodiments of the present invention, each board 208 of each runner 204 has first holes 212, while each elongated bar 206 of the frame 202 has second holes 214 aligned with the first holes 212. Screws or bolts 216 traverse the first holes 212, the mesh 200, and the second holes 214, to secure the runners 204 to the mesh 200 and to the frame 202.

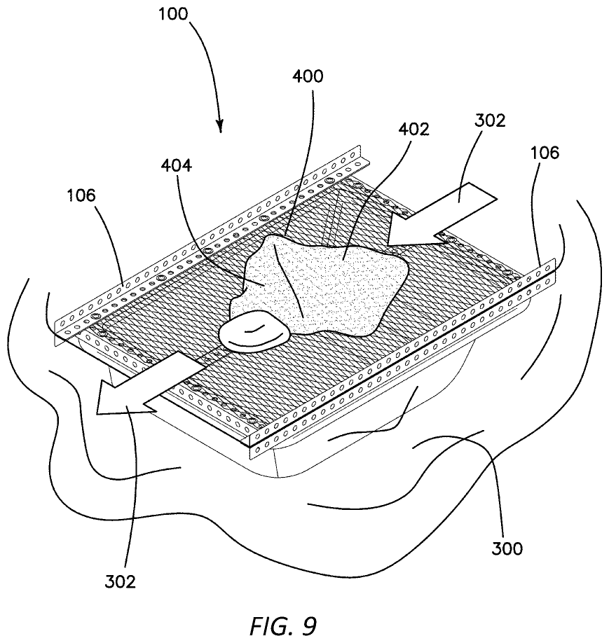

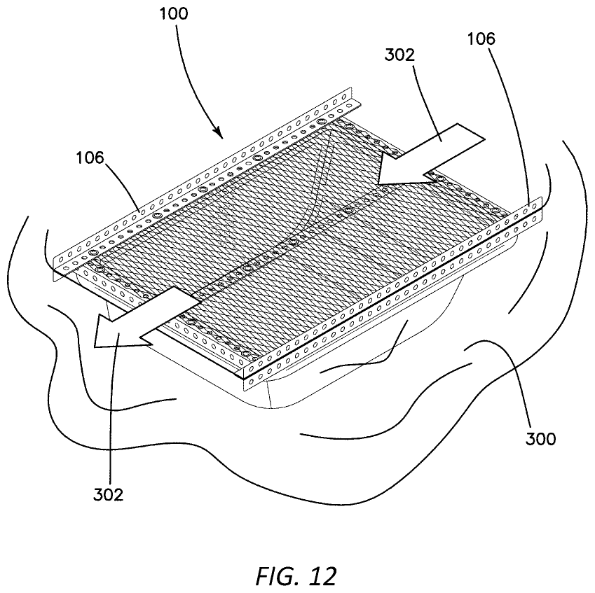

FIGS. 8-14 illustrate different stages in the use of the classifying device 100, according to some embodiments of the present invention.

In FIG. 8, the classifying device 100 described above in any of FIGS. 1-7 is placed in a stream of water 300, with the screen just below water level and the flanges 106 extending above water level. The stream has a water flow in the direction 302. The classifying device 100 is position so that the flanges 106 are substantially parallel to the direction of the water flow 302. The unflanged sides of the device provide openings for water to enter the space between the flanges 106, flow above the screen, and then leave the space between the flanges 106 without blocking the flow of water. The water flow 302 over the screen 102 is substantially unimpeded along the direction of the water flow, while the flanges 106 decrease the escape of the water through the sides of the classifying device. In this manner the speed of the water flow over the stream is increased in the direction of the water flow. In this manner, undesirable material from a deposit is more quickly carried away by the water's flow.

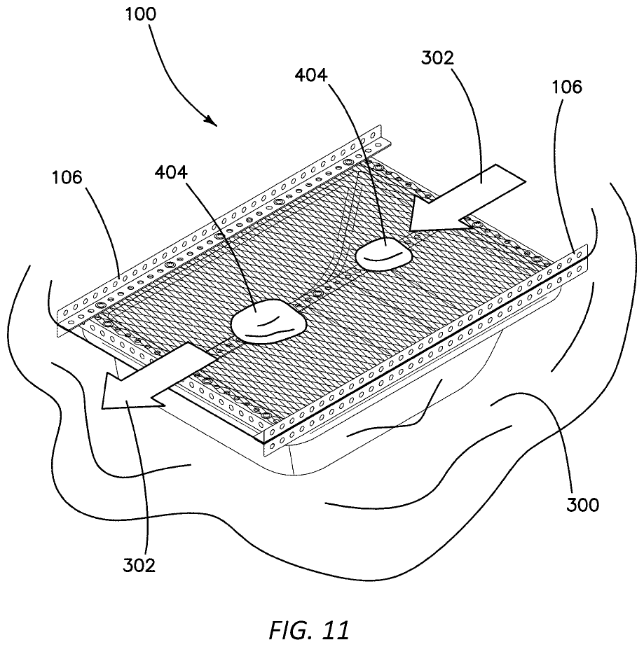

Deposit 400 from the stream is placed on the screen (e.g., shoveled onto the screen). Water flows over the screen, carrying the lighter materials 402 of the deposit (e.g., sand) away, as seen in FIGS. 10-12. Moving around the deposit on the screen may accelerate this process, by spreading the deposit over the screen and thereby helping the water flow carry away the undesirable material.

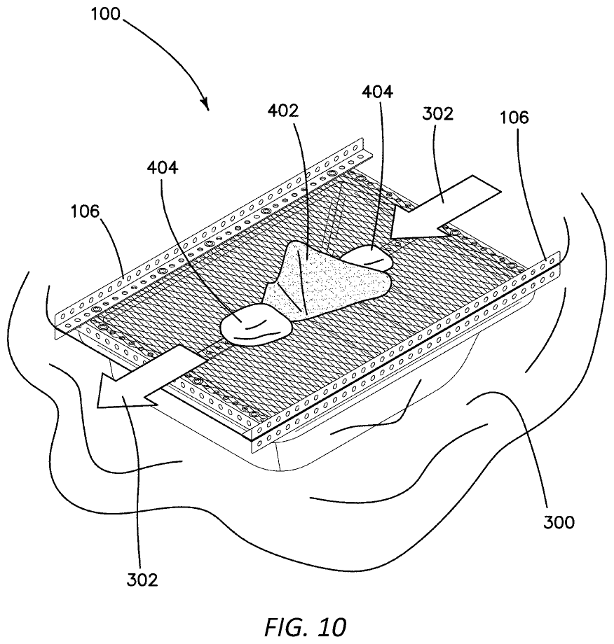

Flakes of heavier material of the deposit, such as gold, traverse the mesh of the screen and are caught by the bin. Larger materials 404, such as rocks, are retained by screen, as seen in FIGS. 9-11.

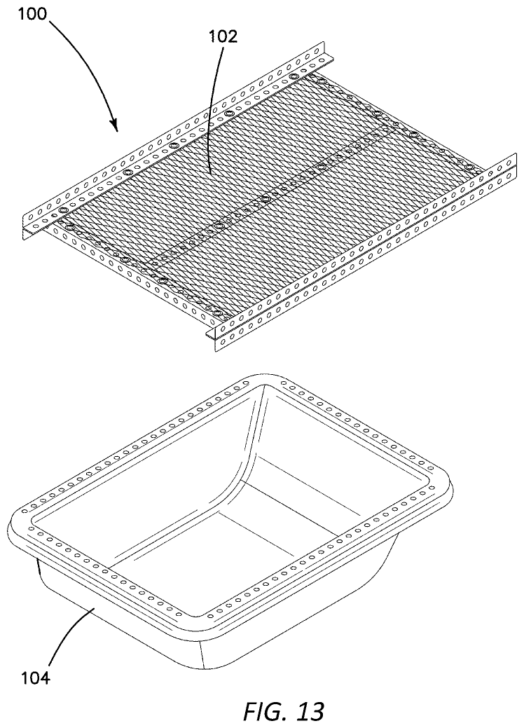

In FIG. 12, the large materials 404 are easily removed by a user from the top of the screen (e.g., shoveled away), after the lighter materials 402 have been carried away and the heavier material below a certain size has traversed the screen. This process is repeated in order to collect gold.

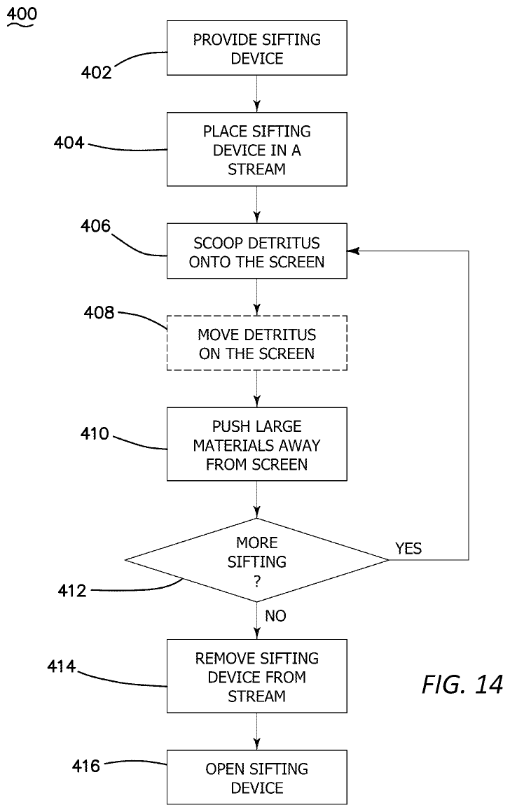

In FIG. 13, the classifying device 100 is removed from the stream. The screen 102 is removed from the bin 104, in order to collect the flakes of heavier material caught in the bin. Optionally, if the screen is not removable, the bin 104 is openable in order to allow collection of the material caught by the bin.

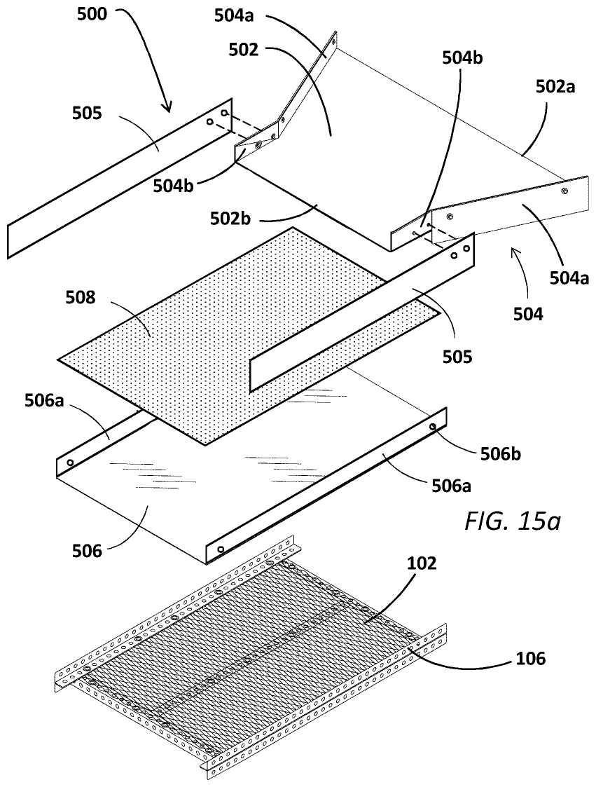

FIG. 14 is a flowchart 400 illustrating a method for classifying in a stream, according to some embodiments of the present invention.

At 402, a classifying device as described in any of the FIGS. 1-7 is provided. At 404, the classifying device is placed in a stream, so that the screen of the classifying device is just below the water level, the flanges extend above water level, and the flanges are substantially parallel to the direction of the water flow.

At 406, detritus from the bed of the stream is placed on the screen of the classifying device. Water flows over the screen, carrying the lighter materials of the deposit (e.g., sand) away, while flakes of heavier material of the deposit, such as gold, traverse the mesh of the screen and are caught by the bin. Optionally at 408, the detritus is moved/spread over the screen to help the water flow carry away the undesirable material.

At 410, when only the heavier and larger material (e.g., rocks) is left on the screen, the heavier material is pushed (e.g. shoveled away) from the screen. At 412, it is decided whether to perform more classifying. If it is decided to perform more classifying, more detritus is scooped onto the screen at 406, and the process is repeated. If no more classifying is to be performed, the classifying device is removed from the stream at 414, and the classifying device is open in order to access and remove the material caught by the bin.

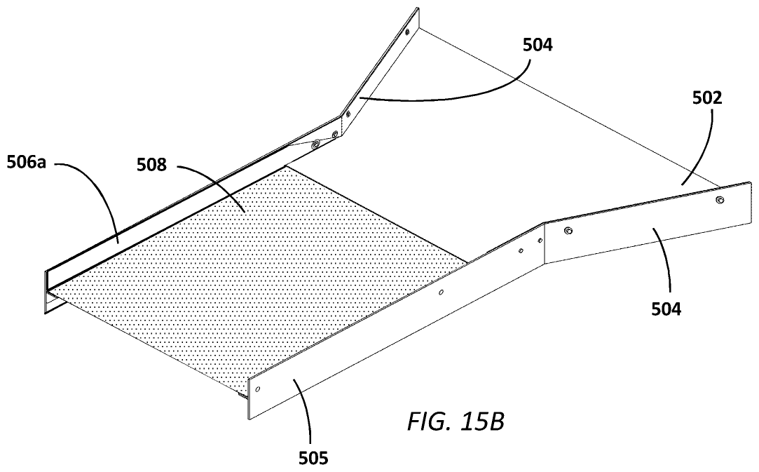

FIGS. 15a and 15b illustrate a flared add-on 500 configured to be removably joined to the screen 102, according to some embodiments of the present invention. FIG. 15a is an exploded view of the flared add-on 500 and the screen 102. FIG. 15b shows the flared add-on 500 joined to the screen 102.

The flared add-on 500 includes a flat surface 502 parallel to the screen 102 and side walls 504 on either lateral side of the flat surface 502. The flared add-on 500 is configured for being joined to the screen 102, so that at least a distal end 502a of the flat surface 502 protrudes away from the screen. Optionally, a proximal end 502b of the flat surface 502 covers part of the screen 102. The distal end 502a of the flat surface 502 is wider than the screen 102. From the distal end 502a, the flat surface 502 tapers to a proximal end 502b. In some embodiments of the present invention, the proximal end 502b is an end of a neck having about the width of the screen 102 and configured for covering part of the screen 102.

The side walls 504 have distal portions 504a and proximal portions 504b. The distal portions 504a are not parallel to each other and follow the tapering of the flat surface 502. The proximal portions 504b are parallel to each other and to the flanges 106 and are configured for being joined to the inner surfaces of the flanges 106. In some embodiments of the present invention, the flared add-on 500 includes two wall extensions 505. Each wall extension is shaped like a flange and is configured for being joined to the outside of the respective flange. Each wall extension 505 is configured for being removably joined to a respective proximal portion 504b, such that at least a portion of the respective flange is sandwiched between the wall extension 505 and the respective proximal portion 504b. In this manner, the flanged add-on 500 can be securely joined to the screen 102. Each wall extension may be joined to the respective flange via any joining mechanism, such as screws, nuts, bolts, etc. Optionally, a screw traversing a wall extension 505 and the respective proximal portion 504a also traverses the respective flange 106.

When joined to the screen 102, the proximal portions 504a of side walls 504 are joined to the flanges 106. The flat surface 502 includes the narrow neck, the narrow neck of the flat section 502 covers a distal portion of the screen 102 and is located between the proximal portions 504a. The flared add-on 500 provides a walled flare extending beyond the distal end of the screen 102 and is configured for direct a larger water volume over the screen 102 in order to enable faster water flow and more efficient operation of the classifying device 100. If the flanges 106 have holes, the wall extensions 505 cover the holes in order to ensure that water flowing over the screen 102 flows along the entirety of the screen 102 and does not exit through the holes. In some embodiments of the present invention, the flared add-on is removably joined to the screen 102.

According to some embodiments of the present invention, the classifying device 100 includes a flat panel 506 and a gold-trapping mat 508. The flat panel 506 is configured to be placed on the screen 102 and be used as a base for supporting a removable gold-trapping mat 508. Placing the flat panel 506 on the screen and the mat 508 on flat panel 508 enables the classifying device to be used as a sluicing device, in which water is driven over the surface of the mat 508, where gold flakes are trapped by the gold-trapping surface of the mat 508. In this manner, the device 102 may be used as a classifying device or a sluicing device, according to the user's desire and need.

In some embodiments of the present invention, the flat panel 506 includes one or two walls 506a. When then flat panel 506 is placed on the screen, the walls 506a are flush with the flanges 106. The walls 506a may have one or more holes 506b aligned with one or more second apertures 107 of the flanges. In this manner, the walls of 506a can be joined to the respective flanges with appropriate elements traversing the holes 506b and the second apertures 107, such as screws, bolts, or any other appropriate element.

The neck of the flat surface 502 covers part of the flat panel 506, and the distal section of the mat 508 is sandwiched between the screen 102 and the neck of the flat surface 502. It should be noted that the flat panel 506 and the gold-trapping mat 508 may be used independently of the flared add-on 500.

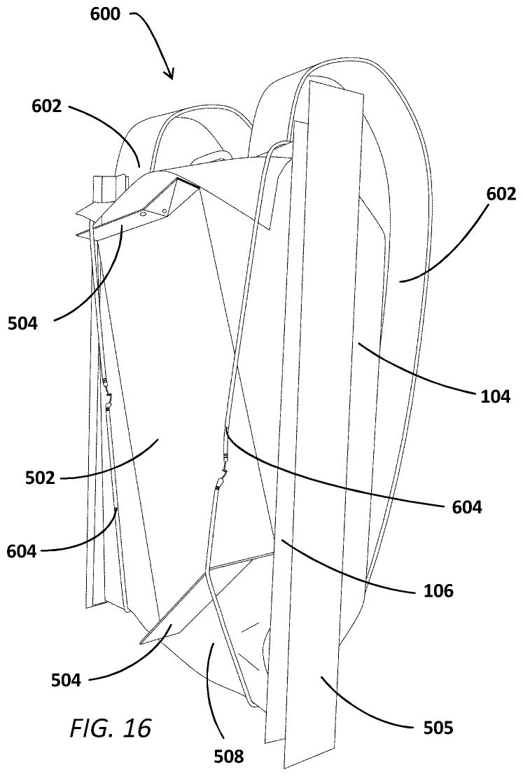

FIG. 16 illustrates a classifying kit 600 configured to be carried by a user.

The kit 600 includes the classifying device 100 of FIG. 1 and shoulder straps 602 attached joined (permanently or removably) to the bin 104 of the classifying device. In carrying mode, the screen and the flanges 106 are joined to the bin 104 as shown in FIGS. 1, 2, and 4b, and the user may wear the kit as a backpack, with the bottom of the bin facing the user and the screen and flanges facing away from the user.

In some embodiments of the present invention, the kit 600 also includes the flared add-on 500 of FIGS. 15a and 15b and a one or more cables 604. Optionally, the kit 600 includes the flat panel 506 and the gold-trapping mat 508 too. When the kit 600 is in the carrying configuration, the flared add-on is disassembled so that the side walls 504 are detached from the flanges 106. The wall extension 505 (if present) are joined to the respective flanges 106. The distal section of the flared add-on 500 (which includes the flat surface 502 and the side walls 504) is tied to the screen via the one or more cables 604. The gold-trapping mat 506 may be located between the proximal portion of the flared add-on 500 and the screen or inside the bin 104.

When the user arrives at the destination and wishes to use the classifying device, the user unties the cables 604, and joins the proximal portions 504a of the side walls 504 to the respective flanges 106. The user may, if he/she chooses to, place the mat 508 on the screen or keep the mat 506 elsewhere. If the shoulder straps 602 are detachable from the bin 104, the user may detach the shoulder straps 602.

The invention is not to be understood as limited to the details of construction and relative arrangements and proportions of parts of the preferred embodiment thereof shown and described, as modifications thereof may obviously be made by those skilled in the art within the spirit and scope of the invention.

What is claimed is:

1. A classifying device comprising:
a bin having an open top face; and
a flat screen extending along a plane and configured for extending over and fully covering the open top face of the bin, the screen having a netting configured to enable passage of material smaller than a desired size therethrough into the bin; and
two flanges disposed at two respective opposite sides of a perimeter of the screen and extending away from the plane of the screen and away from the bin;
wherein the device is configured for being placed in a water stream with a water level just above the screen and the flanges disposed substantially along a direction of a water flow of the stream, to allow unimpeded water flow over the screen between the two flanges, such that the flanges decrease escape of the water through the sides at which the flanges are disposed, thereby increasing a speed of the water flow over the screen in the direction of the water flow of the stream.

2. The device of claim 1, wherein the flanges are perpendicular to the plane of the screen.

3. The device of claim 1, wherein the flanges are parallel to each other.

4. The device of claim 1, wherein the flat screen is removably joined to the bin.

5. The device of claim 1, wherein the flanges are attached to the bin.

6. The device of claim 1, wherein the flanges are joined to the screen.

7. The device of claim 6, wherein the screen comprises:
a frame describing a perimeter of a planar polygonal shape having the two sides opposite to each other which do not touch each other, the flanges extending from the two sides; and
a mesh held by the frame and stretching along the plane of the polygonal shape, the mesh having a netting configured to enabling passage of the material smaller than the desired size therethrough.

8. The device of claim 7, wherein the screen further comprising a stabilizing shaft joined to two non-touching sides of the frame to increase a rigidity of the frame.

9. The device of claim 7, wherein:
each of the two sides of the polygonal shape comprises an elongated bar of the frame and a flanged runner;
each of the flanged runners comprises an elongated planar board and a wall having an edge common with the elongated planar board and extending at an angle from the board;
each of the flanged runners is joined to a respective one of the elongated bars, sandwiching a respective portion of the mesh between the bar and the board of the runner;
each of the walls forms the respective flange.

10. The classifying device of claim 1, further comprising a flared add-on removably joined to the screen, the flared add-on comprising a flat surface and two side walls, wherein:
the flat surface has a distal end longer than a proximal end thereof, the flat surface having two lateral sides tapering from the distal end to the proximal end, the proximal end of the flat surface having a length which is about equal to a length of the screen, the proximal end forming a neck in which the lateral sides are parallel to each other;
each side wall comprises a respective distal portion and a respective proximal portion, the proximal portions being parallel to each other;
each proximal portion being configured for being joined to a respective one of the flanges, so that the flat surface extends distally from screen.

11. The classifying device of claim 10, further comprising two wall extensions, wherein each wall extension is removably attachable to the respective proximal portion.

12. The classifying device of claim 10, wherein the flat surface includes a non-tapering neck extending proximally at the proximal end of the flat surface, the non-tapering neck being configured for covering part of the screen when the add-on is joined to the screen.

13. The classifying device of claim 12, further comprising a flat panel configured for being placed on the screen and a mat having a gold-trapping surface, the mat being configured to be placed on the flat panel to enable the classifying device to be used for gold sluicing, such that a section of the mat is sandwiched between the flat panel and the non-tapering neck.

14. The classifying device of claim 1, further comprising a mat having a gold-trapping surface configured to be placed on the screen to enable sluicing the classifying device to be used for gold sluicing.

15. The classifying device of claim 1 further comprising two shoulder straps joined to the bin, such that the bottom of the bin faces a user then the user wears the shoulder straps.

16. A screen for use in conjunction with a bin for classifying for material in a stream, the screen comprising:
a flat netting extending along a plane and configured for extending over and fully covering an open top face of the bin, the netting being configured to enable passage of material smaller than a desired size therethrough into the bin; and
two flanges disposed at two respective opposite sides of a perimeter of the netting and extending away from the plane of the netting and away from a bottom of the bin.

17. The screen of claim 16, wherein the flanges are perpendicular to the plane of the screen.

18. The screen of claim 16, wherein the flanges are parallel to each other.

19. The screen of claim 16, comprising:
a frame describing a perimeter of planar polygonal shape having the two sides opposite to each other which do not touch each other, the flanges extending from the two sides; and
a mesh held by the frame and stretching along the plane of the polygonal shape, the mesh having a netting configured to enabling passage of the material smaller than the desired size therethrough.

20. The screen of claim 16, wherein:
each of the two sides comprises an elongated bar of the frame and a flanged runner;
each of the flanged runners comprises an elongated planar board and a wall having an edge common with the elongated planar board and extending at an angle from the board;
each of the flanged runners is joined to a respective one of the elongated bars, sandwiching a respective portion of the mesh between the bar and the board of the runner;
each of the walls forms the respective flanged.
